(19) United States
(12) Patent Application Publication
(10) Pub. No.: US 2018/0240350 A1
(43) Pub. Date: Aug. 23, 2018

(54) APPARATUS FOR COMBINING COGNITIVE REASONING AND PHYSICAL MOVEMENT

(71) Applicant: Cognitive Fitness LLC, Boca Raton, FL (US)

(72) Inventors: Benjamin White, Delray Beach, FL (US); Martin Miller, Palm Beach Gardens, FL (US)

(21) Appl. No.: 15/898,534

(22) Filed: Feb. 17, 2018

Related U.S. Application Data
(60) Provisional application No. 62/460,455, filed on Feb. 17, 2017.

(51) Int. Cl. G09B 1/36; A63F 9/10; A47G 27/02

(52) U.S. Cl. CPC G09B 1/36; A63F 2009/1005; A47G 27/02; A63F 9/10

(57) ABSTRACT

An apparatus for combining cognitive reasoning and physical movement includes a plurality of modular elements, receiving elements, inserts, and instructions. The plurality of modular elements are adjoined together defining a body having an upper, first side and an opposing bottom, second side. The receiving elements are disposed on at least a first side of each modular element and are configured to hold the inserts. The inserts are removable and interchangeable and include indicia. The instructions are for using the apparatus to combine cognitive reasoning and physical movement.

### CROSS-REFERENCE TO RELATED APPLICATION

This application claims priority to U.S. Provisional Application No. 62/460,455, filed Feb. 17, 2017, the disclosure of which is incorporated herein by reference in its entirety.

### FIELD

The present invention relates to the field of cognitive reasoning, and more specifically to the field of tools for use with improving cognitive reasoning.

### BACKGROUND

Improvement in brain function (cognitive function) associated with moderate physical activity has been noticed in both growing children and older adults. The cognitive benefits of physical exercise also last for decades. Parents and teachers can take cue from these findings and ensure they encourage kids to be more active and weave in sports and games within their everyday curriculum and activities.

Additionally, physical activity, particularly aerobic exercise, has recently drawn interest for its potential use in neurorehabilitation. Engagement in physical exercise has been commonly reported as being associated with a reduction in risk for various neurological disorders, notably for cognitive decline, dementia, and Alzheimer's. There is also support linking engagement in physical exercise to a reduced risk for onset of Parkinson's as well as stroke incidence.

It is known to combine physical activity with cognitive reasoning. There is an ongoing need for providing better and more efficient ways to combine physical movement and cognitive reasoning.

### SUMMARY

An apparatus is described that combines cognitive reasoning and physical activity for improving cognitive reasoning.

### BRIEF DESCRIPTION OF THE DRAWINGS

FIG. 1 is a top view of an apparatus in the form of a mat for combining cognitive reasoning and physical movement, according to an example embodiment;

FIG. 2 is a top view of the apparatus of FIG. 1 showing a subject moving on the apparatus;

FIG. 3 is a top view of an alternative apparatus according to the invention;

FIG. 4 is a top view of an example modular element and insert that can be used in connection with FIGS. 1 and 2;

FIG. 5 is a top view of an alternative example modular element that can be used in connection with FIGS. 1 and 2;

FIG. 6 is perspective view of a modular element with a straight edge part being applied to the modular element;

FIG. 7 is a perspective view of a modular element with two straight edge parts being applied at a corner of the modular element;

FIG. 8 is a top view of an alternative modular element with a straight edge applied to two sides and the corner of the modular element;

FIG. 9 is an alternative example of an apparatus in the form of a mat similar to that shown in FIGS. 1-3, but having a circular exterior shape;

FIG. 10 is an alternative example of an apparatus in the form of a mat similar to that shown in FIGS. 1-3, but having an oval shape;

FIG. 11 is an alternative example of an apparatus in the form of a mat similar to that shown in FIGS. 1-3, but having a rectangular shape;

FIG. 12 is an alternative example of an apparatus in the form of a mat similar to that shown in FIGS. 1-3, but having an irregular shape;

FIG. 13 is an alternative example of an apparatus in the form of a mat similar to that shown in FIGS. 1 and 2, but having a triangular shape;

FIG. 14 is an example of different shapes that can be used for the inserts for the modular elements and also depicting different indicia, etc. that can be applied to the inserts;

FIG. 15 is a top view of an example insert that can be used with the modular elements shown in FIGS. 1-2 and 4;

FIG. 16 depicts flash cards that can be used with instructions for use of the apparatus; and

FIG. 17 depicts a view of the mat shown in FIG. 3, with inserts being removed and showing fastening techniques for fastening the inserts to the mat.

### DETAILED DESCRIPTION

It is well established that consistent exercise can promote a long and healthy life. Exercise has been found to be one of the best preventative measures for most physical ailments facing people today. Most people focus on improving the capabilities of their cardiovascular and muscular systems when they exercise, but little emphasis is put on improving cognitive function. The human brain reaches peak performance between the ages of 16 and 25. At some point after the age of 25, cognitive function begins to decline to the point where approximately 50% of the population in their 80s-90s suffer from senility and/or dementia.

The human brain is designed to learn by interacting with the environment. With improvements in technology, lifestyles have become more sedentary, particularly in more technologically advanced countries. Lack of physical activity can cause problems with physical health, but can also causes deterioration of the brain's cognitive abilities.

Current research shows that neurons in the brain that control working memory can be improved by training. Engagement in direct recall games stimulates the brain's ability to challenge its short-term memory. Stimulating the brain to multi-task and solve simple problems during exercise helps to improve overall cognitive function. Challenging an individual to move, while searching out a method to accomplish a cognitive task, stimulates the brain at a very primitive level and helps to awaken the brain's neurons to stimulate neuroplasticity and neurogenesis.

An apparatus 10 is described herein that concerns an improved, efficient mechanism for use in improving cognitive function. The apparatus 10, when combined with instructions to a user 12, provides the user 12 with physical activity while also using cognitive reasoning, with the goal of improving cognitive function. The apparatus 10 is particularly useful with an aging population, but can also be used for children or adults of any age

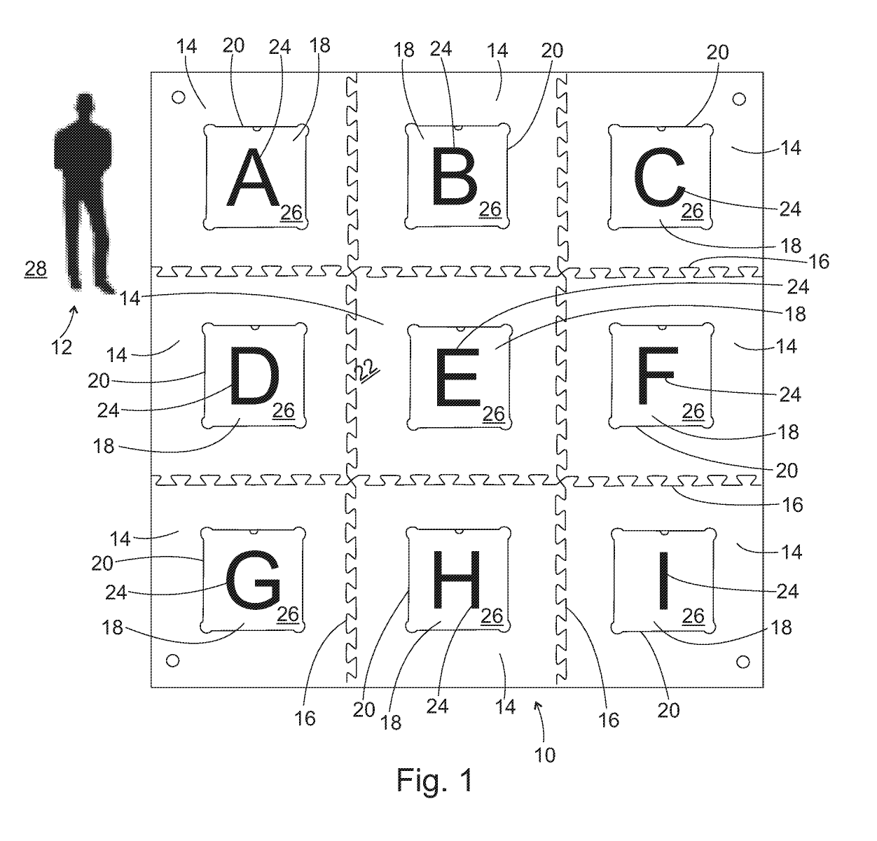

The apparatus 10 shown in FIGS. 1-3 is a substantially planar body 10 that is like a mat 10 in that it can be positioned on a floor and walked on. When the mat 10 is used on the floor, the mat 10 must have a size sufficient to permit a person 12 to move freely from element to element by forming steps or making movements that are consistent in usage of space with walking. The mat 10 can be any size, including of a size that would permit a wheelchair-bound patient to roll from element to element. The mat 10 could also be hung on a wall and used for patients who are immobile (unable to walk or roll on their own). In this instance, the user 12 can point to different elements on the mat 10 as instructed by an instructor or instructions.

The apparatus 10 can be formed of modular components or elements 14 into any desired shape, with the modular components or elements 14 joining together in any known way. One known way for forming a modular element 14 is to have a tongue and groove configuration 16 around the outer edges of each modular element 14 to permit the tongues of one modular element 14 to mate with grooves of another modular element 14. Other means for attaching modular elements 14 may include hook and loop, buttons, snaps, or similar low-profile attaching mechanism.

The modular elements 14 have a thickness that permits an insert 18 to be positioned inside the modular element 14 into a receiving element 20. The insert 18 is visible from at least the top surface 22 of each modular element 14. One type of receiving element 20 may be a recess 20. The insert 18 can extend all the way through the modular element 14 so that it is visible from both the front and rear sides of the modular element 14. Alternatively, the modular element 14 can form a recess 20 that is backed by part of the modular element 14 such that the insert 18 is only visible from the top surface 22 of the modular element 14. In the latter instance, the modular element 14 may be formed from two sheets of material that are sandwiched together, with the top sheet having a recess 20 for receiving an insert 18 and the bottom sheet being solid. Other ways to form the modular elements 14 will be readily evident to those of skill in the art.

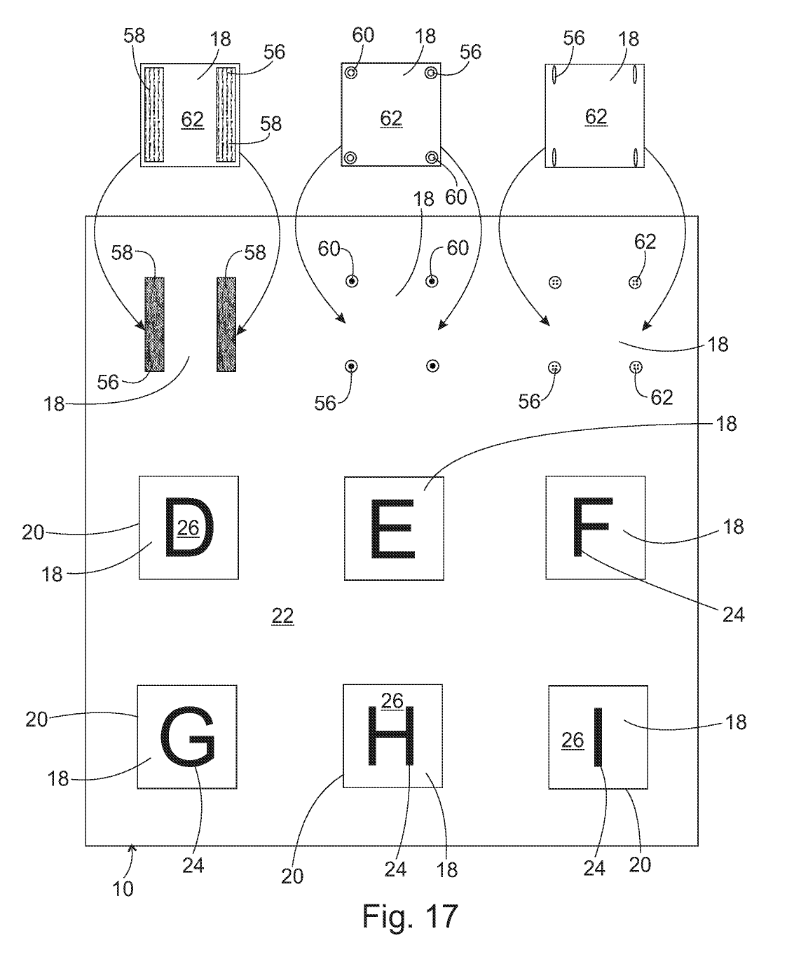

The recesses 20 in the modular elements 14 are generally all the same shape so that interchangeable inserts 18 can be used in the recesses 20. The recesses 20 are for receiving the inserts 18. The recesses 20 can take on simple shapes, such as symmetrical shapes, or more complex shapes, such as those that are non-symmetrical. The inserts 18 are removable, replaceable, and interchangeable in the recesses 20 to provide a large amount of variation for a user 12. The inserts 18 are shaped and sized to fit tightly within each recess 20 and have substantially the same shape as the recess 20 such that they do not pose a tripping hazard but can be removed and replaced with other inserts 18. The inserts 18 can be formed by cutting the inserts 18 out of a piece of material that forms the modular elements 14. The inserts 18 may be puzzle shaped. The inserts 18 may snap into each recess 20 or be held in each recess 20 by tension provided by the insert 18 against the walls of the recess 20. The recess 20 may also include fasteners, such as Velcro, snaps, or other types of fasteners that have a low profile, as shown in FIG. 17. The inserts 18 are substantially planar on at least the bottom surface 64 so that the shape of the inserts 18 permits them to seat flat within the recesses 20.

Alternatively, the apparatus 10 can be formed as a singular mat 10 with inserts 18 that attach to a surface of the mat 10, as shown in FIG. 17. The inserts 18 could attach to a top surface 22 of the mat 10, or a bottom surface of the mat 10 or both, such that the mat 10 can be flipped over to provide additional insert 18 possibilities. In each case, the inserts 18 are removable, replaceable, and interchangeable. They may be attached using any known means of attachment, such as Velcro, buttons, snaps, or other fasteners.

The inserts 18 may include any type of indicia 24 thereon. For example, the inserts 18 could include indicia 24 such as numbers, letters, symbols, characters, colors, shapes, patterns, surface treatments, textures, or any combination of indicia 24. The indicia 24 may be positioned on a top side 26 of each insert 18 or could be positioned on both the top and bottom sides 26, 64 of the insert 18 so that they may be flipped over in use. The interchangeability of the inserts 18 provides an almost unlimited number of ways or combinations for combining cognitive reasoning with physical movements. Additionally, the fastening of each insert 18 into each recess 20 can also provide a level or step of cognitive reasoning by requiring a user 12 to remove and replace the inserts 18. For example, a user 12 will have to reason about how to position an insert 18 such that it can be received within the recess 20. Instructions could also include instructing a user 12 to remove one insert 18 and replacing it with another insert 18. This requires a user 12 to first find the insert 18 to be removed and then to remove and replace the insert 18 with another insert 18, making sure the new insert 18 fits properly in the recess 20. If a user 12 must position an insert 18 into the recess 20, then a user 12 must use cognitive reasoning to determine how the removable insert 18 must be inserted to properly lock the insert 18 inside of the recess 20. Other types of inserts 18 may be formed as pockets. Pockets (not shown) could hold the next set of instructions, for example.

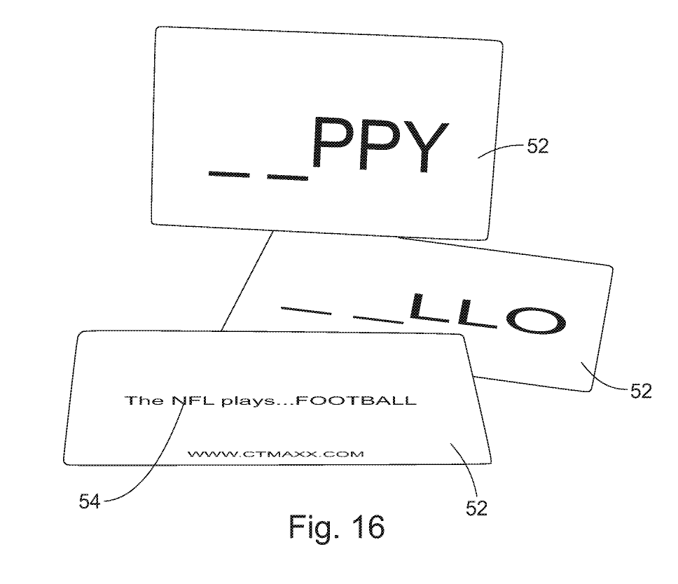

The apparatus 10 is used along with instructions. Instructions can be provided by another person, or by an instruction sheet or booklet. Instructions could be provided by a physical therapist or occupational therapist, for example. Instructions may include telling the user 12 to first move from a starting position 28 to one of the modular elements 14 that has a first insert 18 (e.g., the number 1 on the insert 18). Then the user 12 can be instructed to move to the modular element 14 that has a second insert 18 (e.g., the number 2 on the insert 18). This is a simple form of instructions that involves simply telling a user 12 to move from modular element 14 to modular element 14. The inserts 18 are interchangeable, so that the movements required can be different each time a user 12 uses the apparatus 10. As is evident, this type of instructions can be either verbal or written. A DVD or mobile application could be used to provide instructions, in lieu of a person. Flash cards 52, shown in FIG. 16, can be used to provide the user 12 with a visual cue, such as flash cards that require a user 12 to fill in the missing letters with or without a clue 54. Instructions may be positioned on one side of the flash cards 52 and clues 54 may be positioned on the other side of the flash cards 52.

Another type of instruction may include performing some type of action when reaching each modular element 14. For example, in the example described above, a user 12 could be instructed to touch their toes and hold it for 30 seconds before moving to the next modular element 14. Any number of different types of exercises could be used. In addition, a user 12 could be instructed to perform some type of mental task, such as multiplying 2×6 and stating the correct answer. Thus, both mental and physical exercises can be performed at the same time.

The instruction may require a user 12 to make a cognitive decision based upon the instruction given to the user 12. The instruction may require a user 12 to make a physical movement based upon the cognitive decision made by the user 12 as a result of the instruction received. The physical movement may include requiring the user 12 to move a body part to interact with the indicia 24 on an insert 18.

The instruction may require that the user 12 “spell a four-letter word. To spell the word, place a foot on a letter of one of the inserts 18, then move the opposite foot to the next letter.” Instructions include spelling a word while moving to a specified insert 18. Instructions may be adjusted to increase or decrease the difficulty depending on the level of cognitive ability of the user 12. Instructions may include instructing the user 12 to perform a math problem and then move to the solution of the math problem. For example, the user 12 may be asked what 1+2 equals. Then the user 12 will know to move to the indicia 24 number “3.” Instructions requiring the user 12 to make decisions based upon colors, textures, shapes, or symbols may also be used and are within the spirit and scope of the present invention. One of the inventive features of the present invention is that the interchangeability of the removable inserts 18 may provide for a much greater amount of cognitive games or instructions.

Referring to the figures, FIG. 1 is a top view of an apparatus 10 for combining cognitive reasoning and physical movement. FIG. 1 depicts a substantially planar mat 10 that is formed by coupling a plurality of modular elements 14 using tongue and groove attachments 16. The mat 10 may be made of a slip resistant material and have resilience to allow a user 12 to keep their balance while pushing their bodies and minds. The mat 10 may also include moisture resistance technology to make the mat 10 easily washable with soap and water. The mat 10 may also be light weight.

In FIG. 1, nine modular elements 14 are shown that form a square. Each modular element 14 includes a recess 20 for receiving an insert 18 that is puzzle-shaped. In the embodiment shown, letters are used on each insert 18 from A-I. FIG. 1 depicts a user 12 at a starting position 28 that is outside of the mat 10. The modular elements 14 include one center element 30 that has tongue and grooves 16 on all four sides of the modular element 14, four corner elements 32 that have two straight edges and two tongue and groove edges 16, and four side elements 34 that have a straight edge along one side and three tongue and groove edges 16. Each recess 20 in the modular elements 14 shown in FIG. 1 is symmetrical in both the X and Y planes, permitting the inserts 18 to be easily removed and replaced. In addition, as shown, the inserts 18 have a small cut-out 36 along one of the edges of the insert 18 to permit a user 12 to insert their finger into the cut-out 36 to more easily grasp and remove the insert 18 from the recess 20.

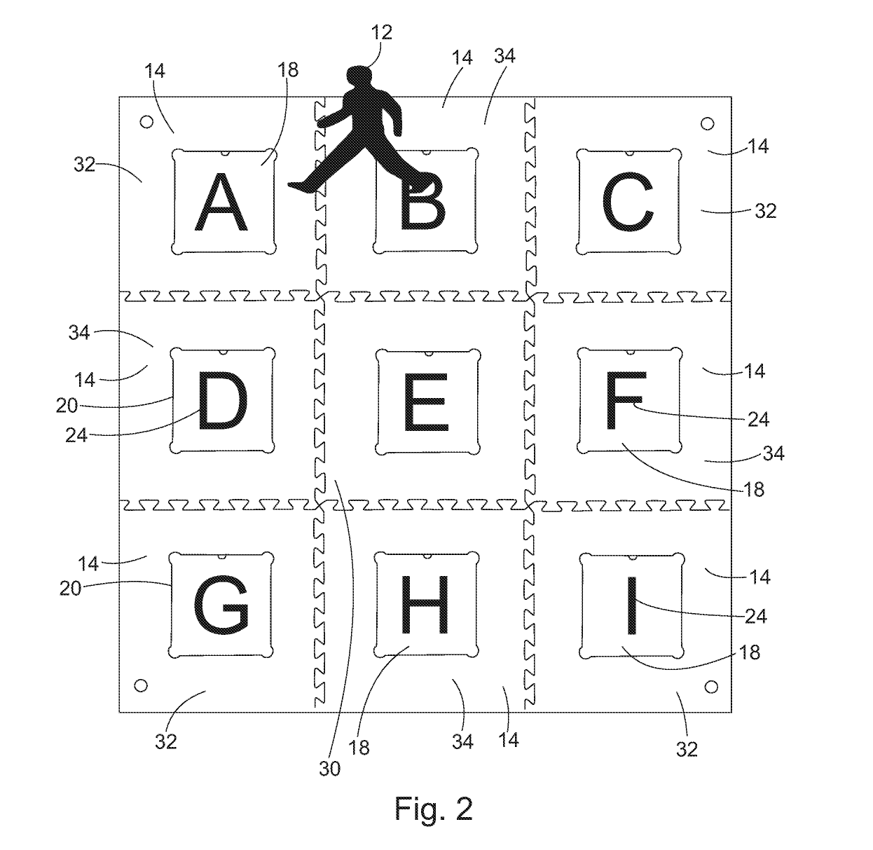

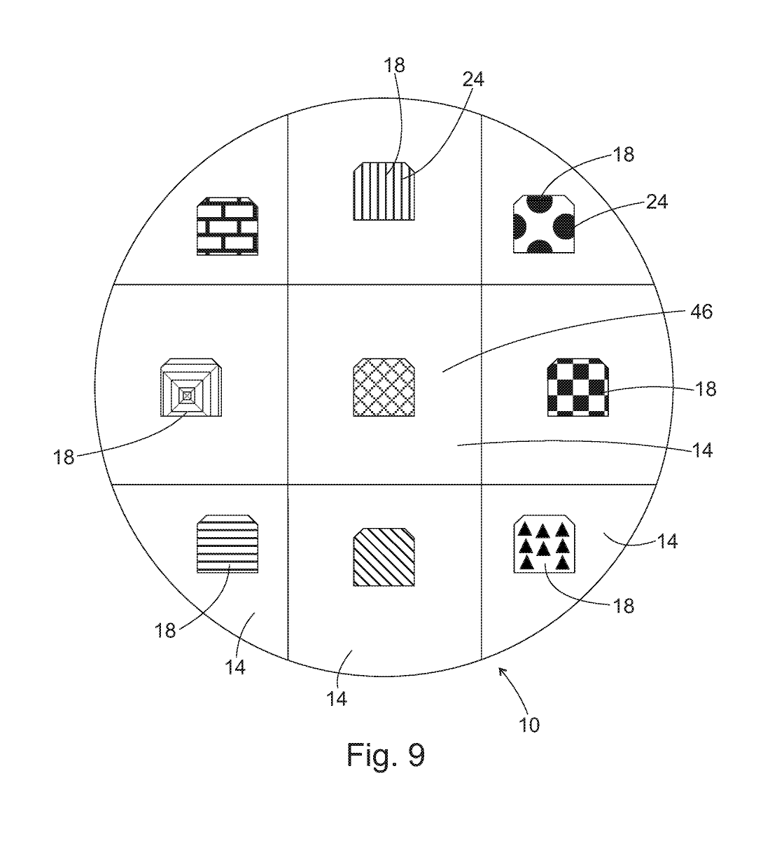

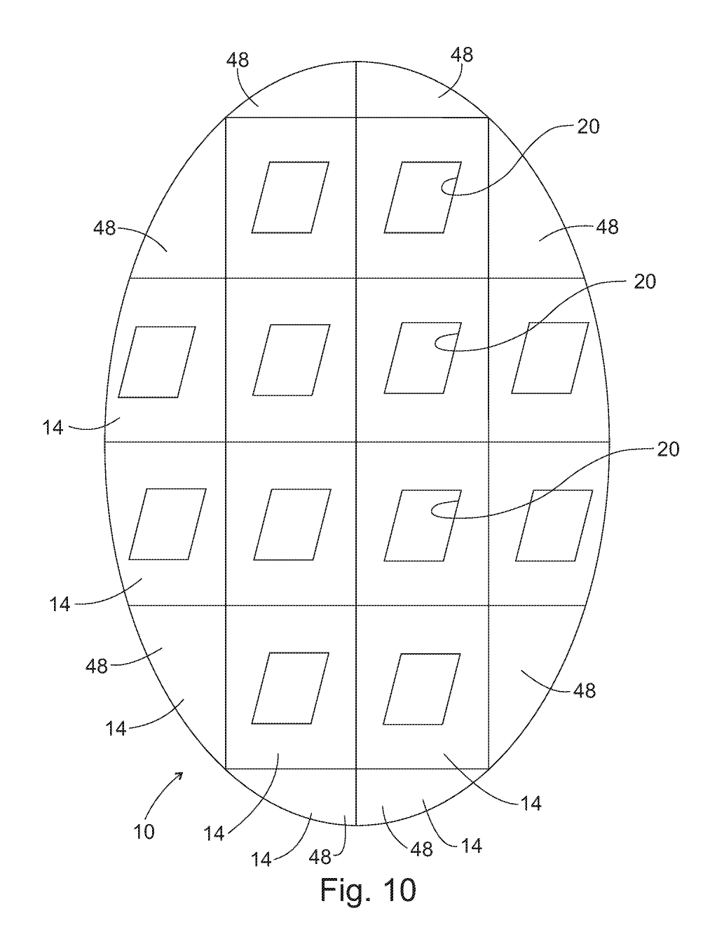

FIG. 2 depicts the same apparatus 10 of FIG. 1, but with a user 12 following instructions on the mat 10. In this example, the user 12 is moving (e.g., walking) from the modular element 14 having insert “B” to the modular element 14 having insert “A”. Modular elements 14 are useful in that they permit any number of different modular elements 14 to be joined together to provide either a small field or a large field. In addition, modular elements 14 can be used to provide different shapes instead of a square. For example, modular elements 14 can be used to provide a circle, oval, rectangle, irregular shape, or triangle, among other possible mat 10 shapes. Examples of other possible shapes are shown in FIGS. 9-13.

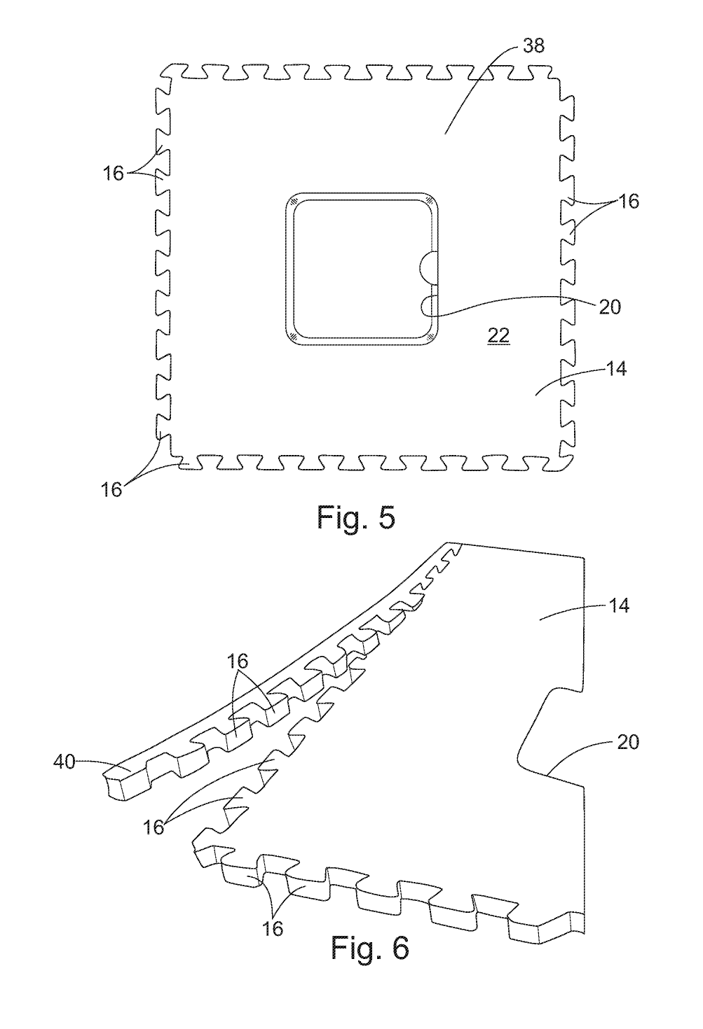

The examples shown herein are non-limiting and other shapes may be used. For example, rectangular modular elements 14 can be used to provide an I-shape or a T-shape, or any number of other shapes (not shown). A combination of rectangular and rounded shapes may be put together to form circles, ovals, or other irregular shapes, as shown in FIGS. 9-10 and 12. In addition, while the embodiment shown in FIGS. 1 and 2 has straight edges built into the modular elements 14, other designs, as shown in FIGS. 5-8, may be provided with straight edges 40 that are removable to provide for greater modularity.

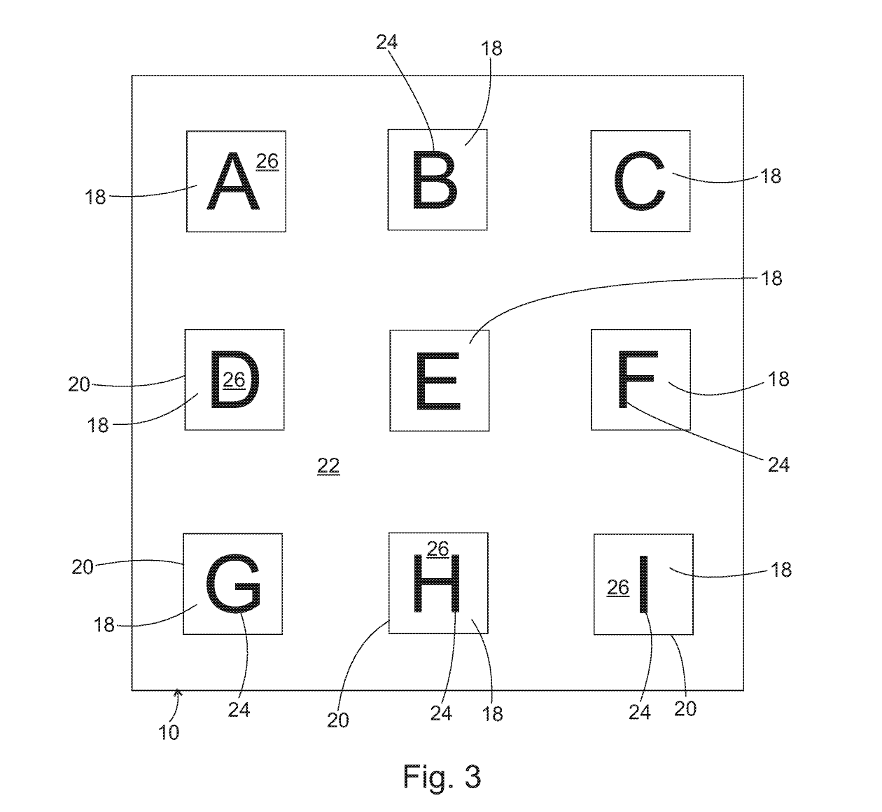

FIG. 3 depicts an alternative mat 10 that is not modular, but that has removable inserts 18 that are interchangeable. The inserts 18 may be positioned in recesses 20 defined in the mat 10 or may utilize fasteners 56 for attaching the inserts 18 to a surface 22 of the mat 10, as shown in FIG. 17. This type of mat 10 could be fabric, quilted fabric (similar to a blanket), foam, or any other type of material that can form a substantially planar mat 10.

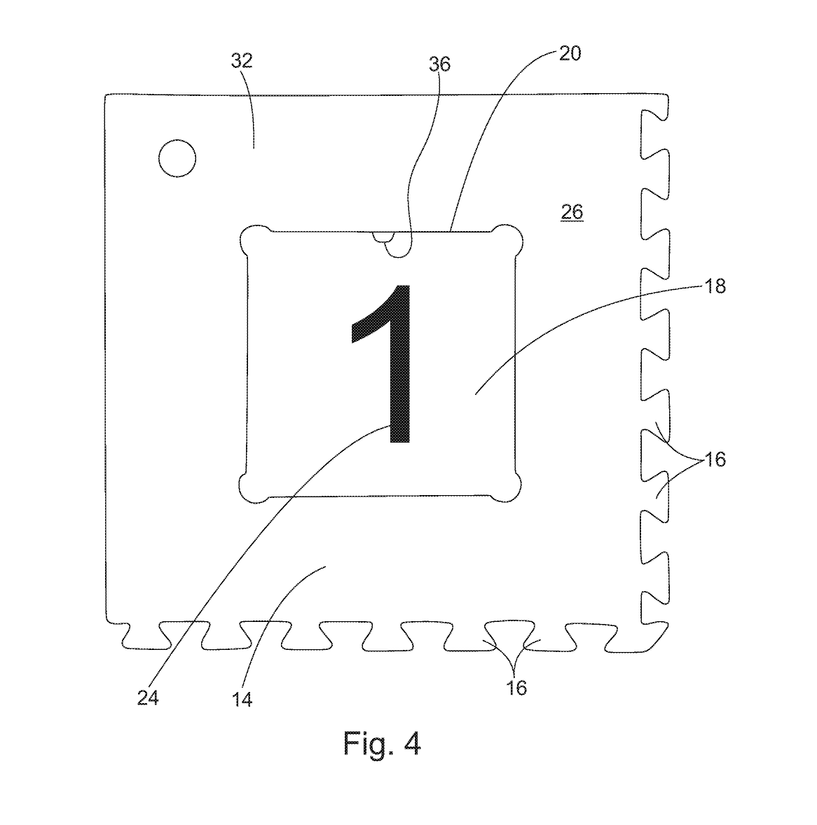

FIG. 4 depicts a first example of a possible modular element 14 configuration that could be used with the examples depicted herein, which is the same as that shown in FIGS. 1-2. The modular element 14 depicted is for a corner of the mat 10 and includes tongue and groove attachments 16 on two sides and straight edges on two sides. In this example, the recess 20 extends all the way through the thickness of the modular element 14.

FIG. 5 depicts a second example of a possible modular element 14 configuration that can be used with the examples depicted herein. The modular element 14 includes tongue and groove attachments 16 on all four sides. The recess 20 has a backing 38 that only permits an insert 18 to be entered into the recess 20 from the top surface 22 of the modular element 14.

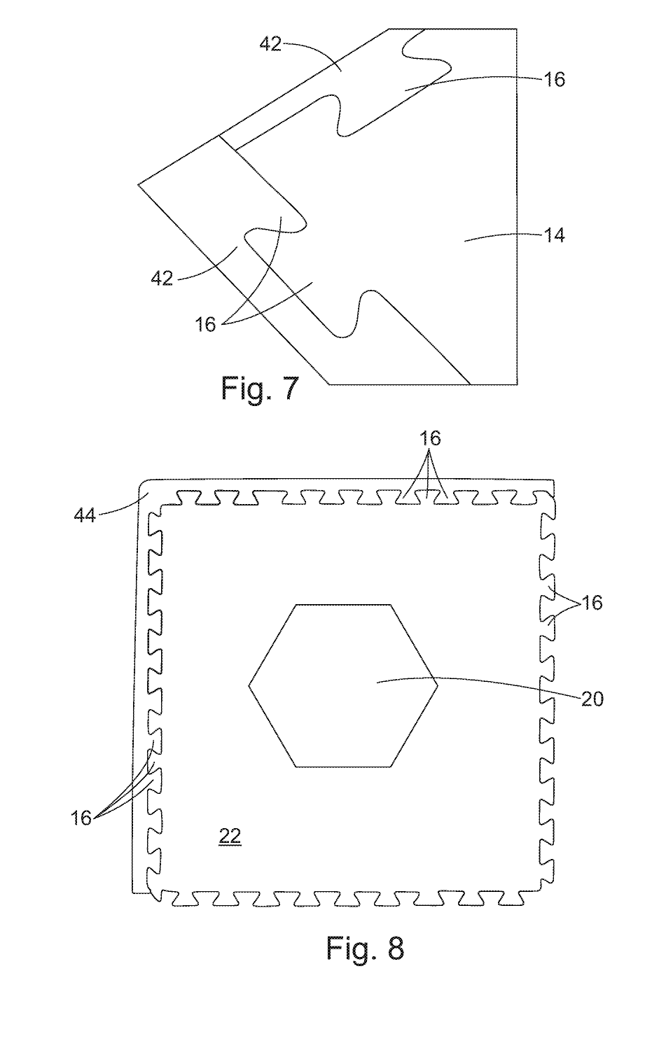

FIGS. 6-8 depict edge pieces 40, 42, 44 that may be applied to the exterior tongue and groove edges of a modular element 14 to make a straight outer edge. FIG. 6 depicts a side edge 40 applied to a side of a modular element 14. FIG. 7 depicts two straight, side edges 42 applied to a modular element 14 to form a corner. FIG. 8 depicts a single corner piece 44 that is applied to opposing side edges that form a corner of the mat 10. In this example, the corner piece 44 is formed as a single member that attaches to the tongue and grooves 16 on two sides of the modular element 14. FIG. 8 also shows a recess 20 that extends all the way through the thickness of the modular element 14.

FIG. 9 depicts a round mat 10 having modular elements 14 of different shapes that are adjoined together. The interior element 46 is substantially rectangular, but the remainder of the modular elements 14 have rounded edges. Any number of modular elements 14 can be used to form a circle. In this example, nine (9) modular elements 14 are used. The modular elements 14 are shown having receiving elements 20 in each of the modular elements 14 for receiving inserts 18. The inserts 18 shown are symmetrical in only one plane and are rectangular shapes with two clipped corners on one side of each rectangle. Each insert 18 includes a different pattern that a user 12 would need to identify. The various modular elements 14 could be coupled together using any known means, or the round mat 10 could be formed as a single piece of material. The inserts 18 may include indicia 24.

FIG. 10 depicts an oval mat 10 having modular elements 14 of different shapes that are adjoined together. FIG. 10 is similar to FIG. 9, except FIG. 10 includes some modular elements 48 that do not include inserts 18, but that are provided to assist in forming the outer oval shape. In this example, a total of twelve (12) modular elements 14 having receiving elements 20 are shown, with eight (8) being rectangular and four (4) having rounded outer edges for forming the oval shape. There are also eight (8) additional rounded edge modular elements that do not have receiving elements for completing the oval shape. The inserts 18 shown are non-symmetrical and formed in the shape of a rhombus. The inserts 18 may include indicia 24.

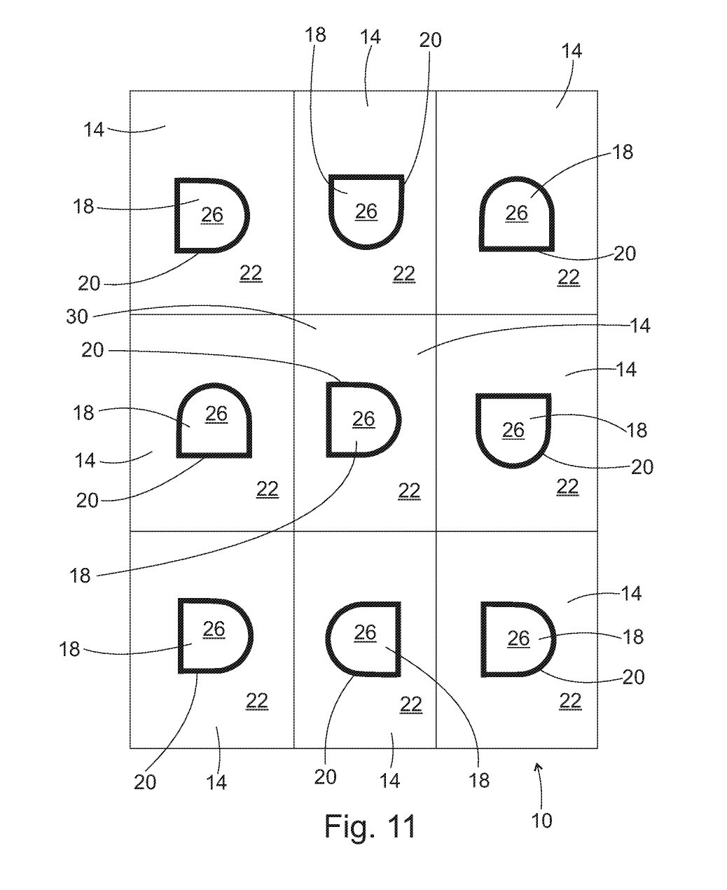

FIG. 11 depicts a rectangular mat 10 having modular elements 14 that are rectangular and are adjoined together. In this embodiment, all the modular elements 14 are the same size and include inserts 18 that are positioned in different directions. The insert shape is that of a “D,” but the modular elements 14 allow the insert's shape to be positioned in different directions depending upon the location of the modular element 14 on the mat 10. The modular elements 14 could be moved around to alter the position of the different shapes of the inserts 18. The shapes may include indicia 24. The D-shape provides for a symmetrical shape in one plane.

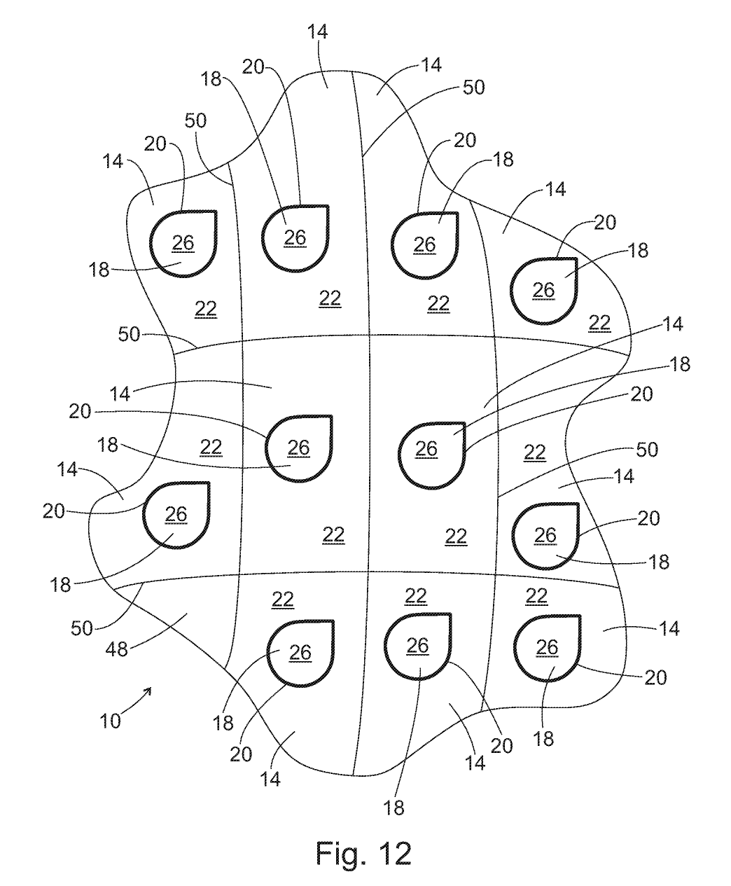

FIG. 12 depicts an irregular shape for the mat 10 where the dividing lines 50 between the various modular elements 14 are curved instead of being straight (as with the prior examples). In this example, the inserts 18 are not centered on each modular element 14 and provide a more varied appearance. In addition, at least one of the modular elements 48 does not include an insert 18. The inserts 18 shown are tear drop shaped and are all oriented in the same direction but could be oriented differently. The tear-drop shape provides for a symmetrical shape in one plane. The inserts 18 may include indicia 24.

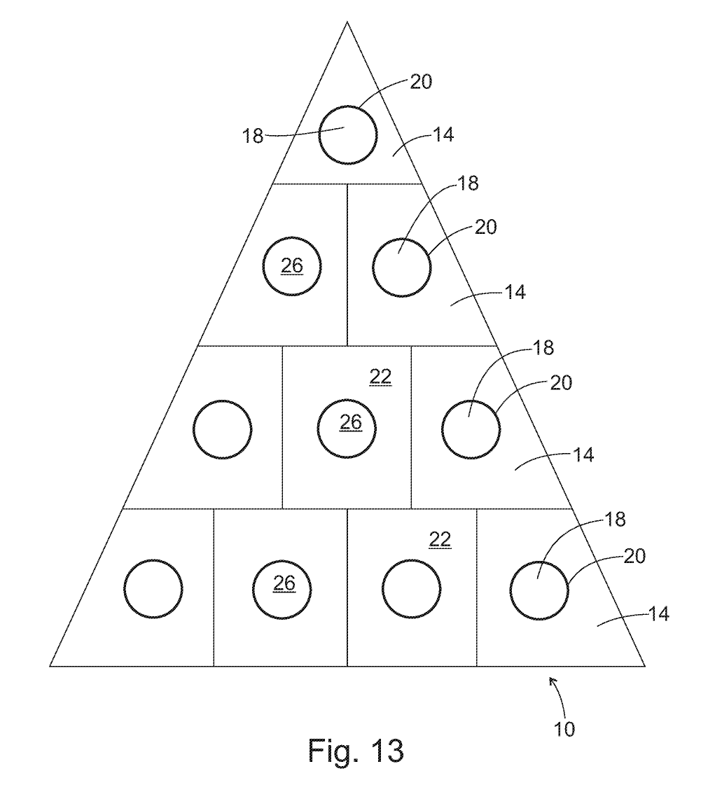

FIG. 13 depicts a triangular shape for the mat 10 with modular elements 14 that are coupled together to form the shape of the triangle. Each of the modular elements 14 has a recess 20 for receiving inserts 18. In this example, the recess 20 and inserts 18 are circular, thus being fully symmetrical. There is one modular element 14 in the top row, two modular elements 14 in the second row, three modular elements 14 in the third row, and four modular elements 14 in the bottom row.

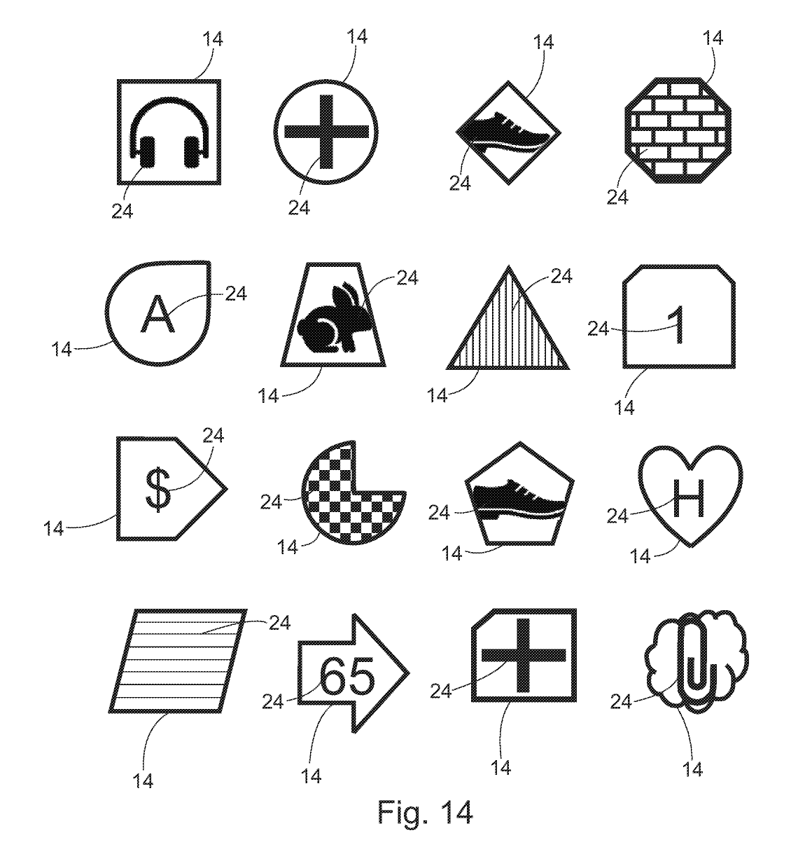

FIG. 14 depicts different shapes for the inserts 18 and different indicia 24 that can be used. The inserts 18 in the top row are symmetrical in both the X and Y planes. The inserts 18 in the second and third rows are symmetrical in one plane, and the inserts 18 in the fourth row are non-symmetrical.

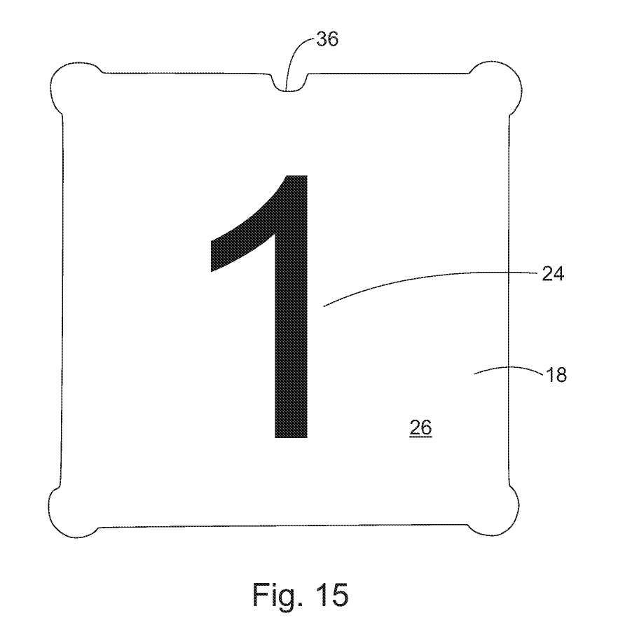

FIG. 15 depicts an example insert 18 that is also shown in FIGS. 1-2. This insert 18 is generally square-shaped with rounded knobs positioned at each of the four corners. The insert 18 is symmetrical in both the X and Y planes. The insert 18 has a cut-out 36 that permits a user 12 to insert their finger into the cut-out 36 to more easily remove the insert 18 from a recess 20 of a modular element 14. The cut-out 36 is shown as a semi-circular shape. The cut-out 36 could be other shapes. Any of the inserts 18 may include a cut-out portion 36 to assist in more easily removing the insert 18 from a recess 20.

FIG. 16 depicts flash cards 52 that can be used with the apparatus 10 to form part of the instructions. The flash cards 52 provide puzzles that a user 12 must solve while performing physical activity. For example, one card 52 may require a user 12 to fill in the missing letters to the puzzle_{——}P P Y, which requires a user 12 to move from a starting position 28 to the first missing letter and then to the second missing letter. The user 12 could first move to the letter “H” and then to the letter “A” to spell the word “HAPPY” or could first move to the letter “H” and then to the letter “I” to spell the word “HIPPY.” The flash cards can include any types of puzzles, including math problems. Clues 54 may be provided on a rear side of the cards to assist an instructor.

FIG. 17 depicts a mat 10 similar to that in FIG. 3, but without inserts 18 coupled to the mat 10. The mat 10 has pre-determined positions where inserts 18 can be attached with fasteners 56. A variety of fasteners 56 are shown, including hook and loop tape 58, snaps 60, and buttons 62. A mating fastener 56 will be disposed on a bottom surface 64 of each insert 18 for attaching to the corresponding fastener on the mat 10. Alternatively, the mat 10 may have a series of fasteners arranged on the top surface 22 of the mat 10 and inserts 18 may be positioned where desired. For example, strips of hook and loop tape 58 may be positioned on the top surface 22 of the mat 10 and inserts 18 may be attached to the hook and loop tape 58 where desired.

Each of the modular elements 14 and inserts 18 may comprise rubber, foam, fabric, polymeric materials such as plastic, polyvinyl chloride (PVC) plastic, vinyl, silicone, etc. or any combination thereof. Additionally, other materials, shapes, textures, sizes, and colors may be used for each of the parts and are within the spirit and scope of the present invention.

In a first example embodiment, an apparatus 10 for combining cognitive reasoning and physical movement includes a plurality of modular elements 14, receiving elements 20 associated with the modular elements 14, inserts 18 for seating in the receiving elements 20, and instructions for using the apparatus 10. The plurality of modular elements 14 are adjoined together defining a body 10 having an upper, first side 22 and an opposing bottom, second side. Each of the plurality of modular elements 14 comprises a plurality of interlocking elements 16 configured to mate with the interlocking elements 16 of adjacent modular elements 14. The receiving element 20 is disposed on at least the first side 22 of at least some of the modular elements 14. Each receiving element 20 is configured for holding an interchangeable and removable insert 18 so that a first side 26 of each insert 18 is visible from the first side 22 of the modular element 14. A plurality of removable and interchangeable inserts 18 are provided, with each insert 18 having indicia 24 on at least a first side of the insert 18. The instructions for using the apparatus 10 combine cognitive reasoning and physical movement.

The interlocking elements 16 may be tongue and groove attachments. The receiving body 10 may be a substantially planar body or a planar body. The body 10 may be a mat 10. Each receiving element 20 may be a recess 20 for receiving the insert 18. Each recess 20 may be oriented in the same direction on each modular element 14 when the modular elements 14 are assembled into a body 10. The recesses 20 may alternatively be oriented in different directions on each modular element 14 when the modular elements 14 are assembled into a body 10. Each receiving element 20 may comprise a symmetrical or a non-symmetrical shape.

The indicia 24 on each insert 18 may comprise a letter, number, symbol, shape, color, surface treatment, pattern, character, or any combination thereof. Each removable insert 18 may include indicia 24 on a first side 26 and a second side thereof, so that each insert 18 can be flipped over to provide a different indicia 24.

A method of using the apparatus 10 may include providing an instruction to a user 12 that requires cognitive reasoning by the user 12 and requiring a user 12 to make a physical movement based upon the instruction. The physical movement may include the user 12 moving a body part to interact with the indicia 24 of at least one insert 18. The method may also include requiring a user 12 to make a cognitive decision based upon the instruction and requiring the user 12 to make a physical movement based upon the cognitive decision.

In another example embodiment, a mat 10 for improving cognitive function includes a planar or substantially planar body 10 defining a shape of the mat 10, with the body 10 having a top surface 22 and a bottom surface, a plurality of receiving elements 20, a plurality of inserts 18, and instructions. The plurality of receiving elements 20 are coupled to at least the top surface 22 of the body 10. The plurality of removable and interchangeable inserts 18 are for coupling with the receiving elements 20 such that a first side of each insert 18 is visible from a top surface 22 of the body 10. Each insert 18 has indicia 24 positioned on at least a top side 26 thereof. The instructions require a user 12 to use cognitive functions while performing physical movements.

The indicia 24 may comprise one or more of numbers, letters, symbols, characters, colors, shapes, patterns, surface treatments, textures, or any combination thereof. The receiving element 20 may be a recess 20 defined through the mat 10. The receiving element 20 may be a recess 20 defined part of the way through the thickness of the mat 10. The receiving element 20 may be a predefined area on the mat 10 that includes a fastener 56 for coupling with an insert 18. The fastener 56 may be hook and loop tape, snaps, buttons, or a combination thereof. The receiving elements 20 may be evenly spaced on the top surface 22 of the mat 10. The receiving elements 20 may be evenly spaced on a bottom surface of the mat 10. The receiving elements 20 may be movable on the top 22 or bottom surface of the mat 10 such that they are evenly spaced from one another or non-evenly spaced from one another.

The term “substantially,” if used herein, is a term of estimation.

While various features of the claimed invention are presented above, it should be understood that the features may be used singly or in any combination thereof. Therefore, the claimed invention is not to be limited to only the specific embodiments depicted herein.

Further, it should be understood that variations and modifications may occur to those skilled in the art to which the claimed invention pertains. The embodiments described herein are exemplary of the claimed invention. The disclosure may enable those skilled in the art to make and use embodiments having alternative elements that likewise correspond to the elements of the invention recited in the claims. The intended scope of the invention may thus include other embodiments that do not differ or that insubstantially differ from the literal language of the claims. The scope of the present invention is accordingly defined as set forth in the appended claims.

What is claimed is:

1. An apparatus for combining cognitive reasoning and physical movement comprising:
a plurality of modular elements adjoined together defining a body having an upper, first side and an opposing bottom, second side, wherein each of the plurality of modular elements comprise a plurality of interlocking elements configured to mate with the interlocking elements of adjacent modular elements;
a receiving element is disposed on at least the first side of at least some of the modular elements, wherein each receiving element is configured for holding an interchangeable and removable insert so that a first side of each insert is visible from the first side of the receiving body;
a plurality of removable and interchangeable inserts, wherein each removable and interchangeable insert has indicia on at least a first side of the insert; and
instructions for using the apparatus to combine cognitive reasoning and physical movement.

2. The apparatus of claim 1, wherein the interlocking elements are tongue and groove attachments.

3. The apparatus of claim 1, wherein the receiving body is a substantially planar body or a planar body.

4. The apparatus of claim 1, wherein the body is a mat.

5. The apparatus of claim 1, wherein each receiving element is a recess for receiving the insert.

6. The apparatus of claim 5, wherein each recess is oriented in the same direction, or the recesses are oriented in different directions, on each modular element when the modular elements are assembled into a body.

7. The apparatus of claim 1, wherein each receiving element comprises a symmetrical or a non-symmetrical shape.

8. The apparatus of claim 1, wherein the indicia on each insert comprises a letter, number, symbol, shape, color, surface treatment, pattern, character or any combination thereof

9. The apparatus of claim 1, wherein each removable insert includes indicia on a first side and a second side thereof, so that each insert can be flipped over to provide a different indicia.

10. A method of using the apparatus of claim 1, comprising:
providing an instruction to a user that requires cognitive reasoning by the user;
requiring a user to make a physical movement based upon the instruction, wherein the physical movement includes the user moving a body part to interact with the indicia of at least one insert.

11. The method of using the apparatus of claim 10, further comprising requiring a user to make a cognitive decision based upon the instruction and requiring the user to make a physical movement based upon the cognitive decision.

11. A mat for improving cognitive function comprising:
a planar or substantially planar body defining a shape of the mat, with the body having a top surface and a bottom surface;
a plurality of receiving elements coupled to at least the top surface of the body;
a plurality of removable and interchangeable inserts for coupling with the receiving elements such that a first side of each insert is visible from a top surface of the body, wherein each insert has indicia positioned on at least a top side thereof; and
instructions for requiring a user to use cognitive functions while performing physical movements.

12. The mat of claim 11, wherein the indicia comprises one or more of numbers, letters, symbols, characters, colors, shapes, patterns, surface treatments, textures, or any combination thereof.

13. The mat of claim 11, wherein the receiving element is a recess defined all the way through the thickness of the mat.

14. The mat of claim 11, wherein the receiving element is a recess defined part of the way through the thickness of the mat.

15. The mat of claim 11, wherein the receiving element is a predefined area on the mat that includes a fastener for coupling with an insert.

16. The mat of claim 15, wherein the fastener is hook and loop tape, snaps, buttons, or a combination thereof.

17. The mat of claim 11, wherein the receiving elements are evenly spaced on the top surface of the mat.

18. The mat of claim 17, wherein receiving elements are evenly space on a bottom surface of the mat.

19. The mat of claim 11, wherein the receiving elements are movable on the top or bottom surface of the mat such that they are evenly spaced from one another or non-evenly spaced from one another.
